(19) United States
(12) Patent Application Publication
(10) Pub. No.: US 2012/0100417 A1
(43) Pub. Date: Apr. 26, 2012

(54) ELECTROLYTE COMPOSITIONS AND METHODS OF MAKING AND USING THE SAME

(76) Inventor: Dorai Ramprasad, Columbia, MD (US)

(21) Appl. No.: 13/379,298

(22) PCT Filed: Jun. 17, 2010
(86) PCT No.: PCT/US10/39022

§ 371 Date: Dec. 19, 2011

Related U.S. Application Data
(60) Provisional application No. 61/218,717, filed on Jun. 19, 2009.

(51) Int. Cl. H01M 2/02; H01G 9/035; H01M 10/056; H01G 9/00

(52) U.S. Cl. 429/163; 361/500; 252/62.2; 429/188; 429/200; 429/207; 429/338; 429/342; 429/341; 429/332

(57) ABSTRACT

Electrolyte compositions suitable for use in batteries, such as a lithium ion battery, are disclosed The electrolyte compositions include functionalized metal oxide particles In several embodiments the compositions utilize the presence of solvent or a scavenger Methods of making and using electrolyte compositions are also disclosed Articles of manufacture containing an electrolyte composition are also disclosed

### FIELD OF THE INVENTION

The present invention is directed to electrolyte compositions suitable for use in batteries, such as a lithium ion battery. The present invention is further directed to methods of making and using electrolyte compositions suitable for use in batteries. The present invention is even further directed to articles of manufacture (e.g., batteries) comprising the herein described electrolyte compositions.

### BACKGROUND OF THE INVENTION

U.S. Pat. No. 5,965,299 (hereinafter, “the '299 patent) discloses the use of surface modified fumed silica as a component in “composite electrolytes.” The disclosed composite electrolytes of the '299 patent comprise (i) fumed silica particles having polymerizable groups extending from surfaces thereof, (ii) a dissociable lithium salt, and (iii) a bulk medium, which contains the fumed silica particles and the dissociable lithium salt. The polymerizable groups of the fumed silica particles are polymerized to form a crosslinked, three-dimensional network within the bulk medium. See, for example, column 3, lines 28-42 of the '299 patent.

Polymeric or gelled electrolytes, such as the composite electrolytes of the '299 patent, typically exhibit increased electrolyte viscosity, which results in a decrease in the ion diffusion coefficient of the electrolyte. It is believed that increased viscosity of a given electrolyte limits the size of Li dendrite growth in Li ion batteries, which results in lower surface area interaction between the electrolyte and the Li electrode, as well as decreased impedance at the Li/electrolyte interface.

Efforts continue to develop new electrolyte compositions that provide at least one of the following benefits: (1) enhanced ion diffusion/conductivity through the electrolyte composition, and reduce irreversibility between charge/discharge cycles and capacity fade versus cycles (2) stable dispersion and even distribution of components within the electrolyte composition, and (3) ease of formulation (e.g., a method of forming an electrolyte composition that does not require processing steps such as the polymerization step required to form the composite electrolytes of the '299 patent).

### SUMMARY OF THE INVENTION

The present invention relates to the discovery of electrolyte compositions that provide (1) exceptional ion conductivity, and reduced irreversibility between charge/discharge cycles and capacity fade versus cycles (2) stable dispersion and even distribution of components within the electrolyte composition, and (3) ease of manufacturing via a simple dispersing step. The electrolyte compositions may be utilized in a variety of applications, but are particularly useful in electrochemical cells, batteries, and capacitors.

Accordingly, the present invention is directed to electrolyte compositions. In one exemplary embodiment, the electrolyte composition comprises functionalized metal oxide particles; at least one ion pair; and at least one solvent; wherein the functionalized metal oxide particles and the at least one ion are each independently distributed throughout the at least one solvent. Typically, the functionalized metal oxide particles and the at least one ion pair are each independently uniformly distributed throughout the at least one solvent.

In another exemplary embodiment, the electrolyte composition comprises functionalized metal oxide particles; at least one ion pair; and at least one solvent; wherein the functionalized metal oxide particles and the at least one ion pair are each independently distributed throughout the at least one solvent, and the functionalized metal oxide particles comprise one or more functional groups covalently bonded to and extending from at least a portion of an outer surface of the functionalized metal oxide particles, the one or more functional groups comprising:

-M(R)ₓ(R′)_{y}

wherein M comprises a metal or metalloid; each R independently comprises (i) a branched or unbranched, substituted or unsubstituted alkyl group, (ii) a branched or unbranched, substituted or unsubstituted alkenyl group, or (iii) a substituted or unsubstituted aryl group; each R′ independently comprises (i) hydrogen, (ii) a branched or unbranched, substituted or unsubstituted alkyl group, (iii) a branched or unbranched, substituted or unsubstituted alkenyl group, or (iv) a substituted or unsubstituted aryl group; x=0, 1, 2 or 3; y=0, 1, 2,or 3; and (x+y)=1, 2 or 3. In one embodiment, an organic substituent is linked to metal oxide particles via M-O bonds.

In a further exemplary embodiment, the present invention relates to an electrolyte composition comprising functionalized metal oxide particles and at least one solvent, wherein the electrolyte composition is nonelastic when said functionalized metal oxide particles are present in an amount of at least about 10% by weight based on the weight of the electrolyte composition.

In another exemplary embodiment, the present invention relates to an electrolyte composition comprising functionalized metal oxide particles and at least one solvent, wherein the electrolyte composition is in the form of a dispersion.

In an even further exemplary embodiment, the present invention relates to an electrolyte composition comprising functionalized metal oxide particles and at least one solvent, wherein the metal oxide particles trap impurities in the electrolyte. This improves performance of the electrolytes in certain devices, such as batteries.

In another exemplary embodiment, the invention relates to an electrolyte composition comprising functionalized metal oxide particles and at least one solvent, wherein the functionalized metal oxide particles are present in an amount of about 2% or less by weight based on the weight of the electrolyte composition.

In another exemplary embodiment, the invention relates to an electrolyte composition comprising functionalized metal oxide particles, at least one solvent, and at least one scavenger.

The present invention is also directed to methods of making electrolyte compositions. In one exemplary embodiment, the method of making an electrolyte composition comprises dispersing functionalized metal oxide particles and at least one ion pair throughout at least one solvent. The method of making electrolyte compositions of the present invention do not require any further step or steps after the dispersing step to form a given electrolyte composition such as, for example, a polymerization step and/or a heating or cooling step.

The present invention is further directed to methods of using the electrolyte compositions of the present invention. In one exemplary embodiment, the method of using the electrolyte composition of the present invention comprises encapsulating the electrolyte composition within a housing. The housing may be an outer shell of a battery, and further comprise a positive electrode, a negative electrode, and at least one separator positioned within the housing and in contact with the electrolyte composition.

In a further exemplary embodiment, the present invention relates to a method of making an electrolyte composition comprising forming a dispersion having functionalized metal oxide particles in at least one first solvent, adding at least one second solvent to the dispersion, and removing the first solvent from the dispersion.

The present invention is further directed to articles of manufacture comprising the electrolyte compositions of the present invention. In one exemplary embodiment, the article of manufacture comprises a battery (e.g., primary or secondary). In another exemplary embodiment, the article of manufacture comprises a capacitor.

In another exemplary embodiment, the present invention relates to a battery having an electrolyte composition comprising functionalized metal oxide particles and at least one solvent, wherein the metal oxide particles in the electrolyte lower irreversibility between charge/discharge cycles and capacity fade versus cycles.

In another exemplary embodiment, the present invention relates to a battery having an electrolyte composition comprising functionalized metal oxide particles and at least one solvent, wherein said metal oxide particles in the electrolyte improve discharge capacity of the battery when cycling the battery at 60° C. as compared to the electrolyte composition without the metal oxide particles.

In another exemplary embodiment, the present invention relates to a battery having an electrolyte composition comprising functionalized metal oxide particles, at least one solvent, and at least one scavenger, wherein the at least one scavenger in the electrolyte increases conductivity stability of the battery at 60° C. as compared to the electrolyte composition without the scavenger.

These and other features and advantages of the present invention will become apparent after a review of the following detailed description of the disclosed embodiments and the appended claims.

### BRIEF DESCRIPTION OF THE FIGURES

FIG. 1 graphically depicts charge and discharge capacity vs. cycle number of exemplary Li—LiCoO₂ coin cells of Example 3 using various weight:volume ratios of functionalized colloidal silica particles in a 1M LiPF₆ EC-DMC solvent system cycled at C/2 in 4.2-2.8V range at 25° C.;

FIG. 2 graphically depicts impedance Nyquist plots (100 kHz-0.1 Hz) of an exemplary Li—LiCoO₂ coin-cell using Sample electrolyte 7 of Example 2 after 100 cycles, in charged state (3.99V) or discharged state (3.11V), with an equivalent circuit for fitting the data as an inset;

FIG. 3 graphically depicts impedance Nyquist plots of exemplary coin cells of Example 3 after cycling, in the fully charged state;

FIG. 4 graphically depicts Re and R1 values of exemplary cycled coin-cells obtained from data fitting of the Nyquist plots shown in FIG. 3;

FIG. 5 graphically depicts Ragone discharge rate capability plots of exemplary plastic cells formed in Example 3;

FIG. 6 graphically depicts EIS Nyquist plots of exemplary plastic cells formed in Example 3 before cycling;

FIG. 7 graphically depicts an equivalent circuit used for fitting Nyquist plots of the exemplary plastic cells shown in FIG. 6;

FIG. 8 graphically depicts first charge irreversible capacity versus electrolyte functionalized colloidal silica content for exemplary graphite-LiCoO₂ plastic cells formed in Example 3;

FIG. 9 graphically depicts EIS Nyquist plots of exemplary graphite-LiCoO₂ plastic cells formed in Example 3 after cycling.

FIG. 10 graphically depicts capacity versus number of cycles for exemplary graphite-LiCoO₂ plastic cells formed in Example 4 cycling at 25° C., then at 60° C.;

FIG. 11 graphically depicts capacity versus number of cycles for exemplary graphite-LiCoO₂ plastic cells formed in Example 5 cycling at 25° C., then at 60° C.; and

FIG. 12 graphically depicts ionic conductivity versus length of time for exemplary ethylene carbonate dimethyl carbonate electrolyte with 1M LiPF₆ at 60° C. with various additives.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

It must be noted that as used herein and in the appended claims, the singular forms “a”, “and”, and “the” include plural referents unless the context clearly dictates otherwise. Thus, for example, reference to “an oxide” includes a plurality of such oxides and reference to “oxide” includes reference to one or more oxides and equivalents thereof known to those skilled in the art, and so forth.

“About” modifying, for example, the quantity of an ingredient in a composition, concentrations, volumes, process temperatures, process times, recoveries or yields, flow rates, and like values, and ranges thereof, employed in describing the embodiments of the disclosure, refers to variation in the numerical quantity that may occur, for example, through typical measuring and handling procedures; through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

The term “particles” refers to porous or nonporous particles formed via any known process including, but not limited to, a solution polymerization process such as for forming colloidal particles, a continuous flame hydrolysis technique such as for forming fused particles, and a precipitation technique such as for forming precipitated particles. The particles may be composed of metal oxides, sulfides, hydroxides, carbonates, silicates, phosphates, etc, but are preferably metal oxides. The particles may be a variety of different symmetrical, asymmetrical or irregular shapes, including chain, rod or lath shape. The particles may have different structures including amorphous or crystalline, etc. The particles may include mixtures of particles comprising different compositions, sizes, shapes or physical structures, or that may be the same except for different surface treatments. Preferably, the metal oxide particles are amorphous.

As used herein, “metal oxides” is defined as binary oxygen compounds where the metal is the cation and the oxide is the anion. The metals may also include metalloids. Metals include those elements on the left of the diagonal line drawn from boron to polonium on the periodic table. Metalloids or semi-metals include those elements that are on this line. Examples of metal oxides include silica, alumina, titania, zirconia, etc., and mixtures thereof.

The term “colloidal metal oxide particles” refers to amorphous, nonporous metal particles formed via a multi-step process in which acidification of sodium silicate solution yields Si(OH)₄, which is subsequently polymerized under basic conditions (e.g., pH>7.0) to form the amorphous, nonporous silica particles with or without a Si atom substitution step (e.g., substitution of some Si atoms with Al or other atoms to alter the overall surface charge of the resulting particles).

The term “functionalized metal oxide particles” refers to metal oxide particles that undergo a surface modification in which one or more hydrophibic reactants are covalently bonded to —OH groups positioned along the outer surfaces of the metal oxide particles.

The term “a substituted alkyl group” refers to an alkyl group having one or more substituents thereon, wherein each of the one or more substituents comprises a monovalent moiety containing one or more atoms other than carbon and hydrogen either alone (e.g., a halogen such as F) or in combination with carbon (e.g., a cyano group) and/or hydrogen atoms (e.g., a hydroxyl group or a carboxylic acid group).

The term “a substituted alkenyl group” refers to an alkenyl group having (i) one or more C—C double bonds, and (ii) one or more substituents thereon, wherein each of the one or more substituents comprises a monovalent moiety containing one or more atoms other than carbon and hydrogen either alone or in combination with carbon and/or hydrogen atoms.

The term “a substituted aryl group” refers to an aromatic ring structure consisting of 5 to 10 carbon atoms in the ring structure (i.e., only carbon atoms in the ring structure), wherein a carbon atom of the ring structure is bonded directly to the metal atom, and the ring structure has one or more substituents thereon, wherein each of the one or more substituents comprises a monovalent moiety containing one or more atoms (e.g., a halogen such as F, an alkyl group, a cyano group, a hydroxyl group, or a carboxylic acid group).

The term “non-elastic” is defined as a liquid (e.g., portrays non-Newtonion behavior) such that the viscous modulus dominates the elastic modulus, whereas a “gel” is the converse (as referenced in Journal of the Electrochemical Society 154, A1140-1145(2007)).

The term “electrolyte” is defined as any substance containing free ions that behaves as an electrically conductive medium.

The term “dispersion” is defined as a system in which two (or more) substances are uniformly mixed so that one is extremely finely mixed throughout the other.

The term “stable dispersion” is defined as a dispersion where the particles do not aggregate or agglomerate and separate from the dispersion.

The term “independently distributed” is defined as two or more components in a mixture that are discreet (i.e., are not chemically or physically bonded to one another).

The term “scavenger” is defined as compounds that facilitate dehydration and acid neutralization in electrolyte compositions.

The term “weakly basic” is defined as compounds that may weaken or reduce reactivity of electrolyte components, such as PF₅ formed from the degradation of LiPF₆.

The present invention is directed to electrolyte compositions comprising (i) functionalized metal oxide particles and (ii) at least one ion pair dispersed throughout (iii) at least one solvent. The present invention is further directed to methods of making electrolyte compositions, as well as methods of using electrolyte compositions. The present invention is even further directed to articles of manufacture comprising an electrolyte composition.

A description of exemplary electrolyte compositions and electrolyte composition components is provided below.

### I. Electrolyte Compositions

The electrolyte compositions of the present invention may comprise a number of individual components. A description of individual components and combinations of individual components is provided below. Further, the electrolyte compositions of the present invention may be presented in various forms. A description of types of electrolyte compositions is also provided below.

In one exemplary embodiment, the electrolyte composition comprises functionalized metal oxide particles; at least one ion pair; and at least one solvent; wherein the functionalized metal oxide particles and the at least one ion pair are each independently distributed throughout the at least one solvent. Typically, the functionalized metal oxide particles and the at least one ion pair are each independently uniformly distributed throughout the at least one solvent. That is, the at least one ion pair is not incorporated physically or chemically with the functionalized metal oxide particles (i.e., they are discreet from one another).

A. Electrolyte Composition Components

The electrolyte compositions of the present invention may comprise one or more of the following components.

1. Functionalized Metal Oxide Particles

The electrolyte compositions of the present invention comprise functionalized metal oxide particles. Suitable functionalized metal oxide particles for use in the present invention include any surface modified metal oxide particles. Typically, the functionalized metal oxide particles comprise metal oxide particles having one or more hydrophobic functional groups covalently bonded to and extending from the surfaces of the metal oxide particles.

In some exemplary embodiments, the functionalized metal oxide particles comprise one or more functional groups covalently bonded to and extending from at least a portion of an outer surface of the functionalized metal oxide particles, the one or more functional groups comprising:

-M(R)ₓ(R′)_{y}

wherein M comprises a metal or metalloid, each R independently comprises (i) a branched or unbranched, substituted or unsubstituted alkyl group, (ii) a branched or unbranched, substituted or unsubstituted alkenyl group, or (iii) a substituted or unsubstituted aryl group; each R′ independently comprises (i) hydrogen, (ii) a branched or unbranched, substituted or unsubstituted alkyl group, (iii) a branched or unbranched, substituted or unsubstituted alkenyl group, or (iv) a substituted or unsubstituted aryl group; x=0, 1, 2 or 3; y=0, 1, 2 or 3; and (x+y)=1, 2 or 3. In one embodiment, an organic substituent is linked to metal oxide particles via M-O bonds.

In any of the above-described exemplary functionalized metal oxide particles, one or more of R and/or R′ may be substituted with one or more substituents. Suitable substituents on the R and/or R′ groups include, but are not limited to, halogens, hydroxyl groups, alkyl groups, cyano groups, amino groups, carbonyl groups, alkoxy groups, thioalkoxy groups, nitro groups, carboxylic acid groups, carboxylic ester groups, alkenyl groups, alkynyl groups, aryl groups, heteroaryl groups, or combinations thereof. Typical substituents for alkyl groups and alkenyl groups include, but are not limited to, —F, —OH, —CN, and —COOH. Typical substituents for aryl groups include, but are not limited to, alkyl groups, —F, —OH, —CN, and —COOH.

In some exemplary embodiments, the exemplary functionalized metal oxide particles comprise one or more functional groups covalently bonded to and extending from at least a portion of an outer surface of the functionalized metal oxide particles, the one or more functional groups comprising:

-M(R)ₓ(R′)_{y}

wherein M comprises a metal or metalloid, each R independently comprises (i) a branched or unbranched C1-C8 alkyl group, (ii) a branched or unbranched C1-C8 alkyl group substituted with at least one fluoro, amino or glycidoxy substituent, (iii) a branched or unbranched C2-C8 alkenyl group, (iv) a branched or unbranched C2-C8 alkenyl group substituted with at least one fluoro, amino or glycidoxy substituent, (v) a phenyl group, or (vi) a phenyl group substituted with at least one fluoro substituent; each R′ independently comprises (i) hydrogen, (ii) a branched or unbranched C1-C8 alkyl group, (iii) a branched or unbranched Cl -C8 alkyl group substituted with at least one fluoro, amino or glycidoxy substituent, (iv) a branched or unbranched C2-C8 alkenyl group, (v) a branched or unbranched C2-C8 alkenyl group substituted with at least one fluoro, amino or glycidoxy substituent, (vi) a phenyl group, or (vii) a phenyl group substituted with at least one fluoro substituent; x=0 1, 2 or 3; y=0, 1, 2 or 3; and (x+y)=1, 2 or 3. In one embodiment, an organic substituent is linked to metal oxide particles via M-O bonds.

The functionalized metal oxide particles typically have an average particle size of less than about 100 nanometers (nm). As used herein, the term “average particle size” refers to the average of the largest dimension of each particle within a set of particles. In some exemplary embodiments, the functionalized metal oxide particles have an average particle size ranging from about 1.0 to about 80 nm. In other exemplary embodiments, the functionalized metal oxide particles have an average particle size ranging from about 5.0 to about 50.0 nm.

The functionalized metal oxide particles typically have a particle size range of from about 1.0 to about 100 nm. As used herein, the term “particle size” refers to the largest dimension of each particle within a set of particles. In some exemplary embodiments, the functionalized metal oxide particles have a particle size range of from about 5.0 to about 80.0 nm. In other exemplary embodiments, the functionalized metal oxide particles have a particle size range of from about 5.0 to about 50.0 nm.

The functionalized metal oxide particles are typically present in a given electrolyte composition of the present invention in an amount greater than 0 weight percent (wt %) and up to about 50.0 wt % based on a total weight of the electrolyte composition. In some exemplary embodiments, the electrolyte compositions comprise one or more functionalized metal oxide particles in an amount ranging from about 1.0 wt % to about 42.5 wt %. In other exemplary embodiments, the electrolyte compositions comprise one or more functionalized metal oxide particles in an amount ranging from about 3.0 wt % to about 30.0 wt %. In other exemplary embodiments, the electrolyte compositions comprise one or more functionalized metal oxide particles in an amount ranging from about 5.0 wt % to about 12.0 wt %, based on a total weight of the electrolyte composition. In a further embodiment, the functionalized metal oxide particles may be present in the electrolyte in amounts of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, up to about 50 wt % based on the total weight of the electrolyte composition.

A number of commercially available metal oxide particles may be used as starting materials for forming functionalized metal oxide particles used in the present invention. Suitable commercially available metal oxide particles for use as starting materials in the present invention include, but are not limited to, colloidal silica particles commercially available under the trade designation LUDOX® TMA colloidal silica particles from W. R. Grace & Co.-Conn. Other colloidal particles may include any metal oxide, such as, for example, alumina particles that may or may not be functionalized depending on the ability to form a dispersion of the materials, such as those described in U.S. Pat. Nos. 4,731,264 and 6,846,435, and European Patent Publication No. 1757663, the entire subject matter of which is incorporated herein by reference.

In an even further exemplary embodiment, the present invention relates to an electrolyte composition comprising functionalized metal oxide particles and at least one solvent, wherein the metal oxide particles trap impurities in the electrolyte. Certain impurities formed in the electrolyte, such as HF, H₂O, etc., may have a deleterious effect on the ultimate electrical performance of the electrolyte in various devices, such as batteries. In this embodiment, the functionalized metal oxide particles may adsorb impurities and provide the devices with improved performance, such as discharge rate capability and improved cycle life. For example the irreversible capacity may be lowered by up to 99%, 98%, 97%, 96%, 95%, 94%, 93%, 92%, 91%, 90% or less.

2. Ions

The electrolyte compositions of the present invention also comprise at least one ion pair. Suitable ion pairs include, but are not limited to, lithium salts, salts of organic amines with organic acids In some desired embodiments of the present invention, the electrolyte compositions of the present invention comprise lithium ions.

When the electrolyte composition of the present invention comprises lithium ions, the lithium ions may dissociate from one or more lithium salts. Suitable lithium salts include, but are not limited to, lithium hexafluorophosphate, lithium imide, lithium perfluorosulphonimide (LiTFSI), lithium triflate, lithium tetrafluoroborate, lithium perchlorate, lithium iodide, lithium trifluorocarbonate, lithium nitrate, lithium thiocyanate, lithium hexafluoroarsenate, lithium methide, and combinations thereof.

When the electrolyte composition of the present invention comprises one or more ions other than lithium ions (or ions dissociated from a lithium salt), the ions may dissociate from one or more non-lithium salts. Suitable non-lithium salts include, but are not limited to, organic salts, such as organic amine salts as set forth in U.S. Patent Publication No. US 2009/0021893, the entire subject matter of which is incorporated herein by reference.

Typically, each type of ion (e.g., lithium ions) is present in the electrolyte compositions of the present invention in an amount up to about 1.0 wt % based on a total weight of said electrolyte composition. In some exemplary embodiments, each type of ion (e.g., lithium ions) is present in the electrolyte compositions of the present invention in an amount ranging from about 0.1 to about 0.8 wt % based on a total weight of the electrolyte composition. In other exemplary embodiments, each type of ion (e.g., lithium ions) is present in the electrolyte compositions of the present invention in an amount ranging from about 0.2 to about 0.5 wt % based on a total weight of the electrolyte composition.

A number of commercially available salts may be used in the present invention. Suitable commercially available salts for used in the present invention include, but are not limited to, lithium and non-lithium salts commercially available from Novolyte Technologies (Independence Ohio) under the tradename Purolyte®.

3. Solvents

The electrolyte compositions of the present invention further comprise one or more solvents. The solvents may include a mixture of non-aqueous, aprotic, and polar organic compounds. Generally, solvents may include carbonates, carboxylates, ethers, lactones, sulfones, phosphates, and nitriles. Suitable solvents include, but are not limited to, ethylene carbonate, dimethyl carbonate, dimethyl carbonate, propylene carbonate, diethyl carbonate, polyethylene oxide, ionic liquids, and mixtures thereof. Useful carbonate solvents herein include but are not limited to cyclic carbonate such as ethylene carbonate, propylene carbonate, butylene carbonate, and linear carbonate such as dimethyl carbonate, diethyl carbonate, di(2,2,2-trifluoroethyl)carbonate, dipropyl carbonate, dibutyl carbonate, ethyl methyl carbonate, 2,2,2-trifluorethyl methyl carbonate, methyl propyl carbonate, ethyl propyl carbonate, 2,2,2-trifluorethyl propyl carbonate. Useful carboxylate solvents include but not limited to methyl formate, ethyl formate, propyl formate, butyl formate, methyl acetate, ethyl acetate, propyl acetate, butyl acetate, methyl propionate, ethyl propionate, propyl propionate, butyl propionate, methyl butyrate, ethyl butyrate, propyl butyrate, butyl butyrate. Useful ethers include but not limited to tetrahydrofuran, 2-methyl tetrahydrofuran, 1,3-dioxolane, 1,4-dioxane, 1,2-dimethoxyethane, 1,2-diethoxyethane, 1,2-dibutoxyethane, methyl nonafluorobutyl ether, ethyl nonafluorobutyl ether. Useful lactones include but not limited to γ-butyrolactone, 2-methyl-γ-butyrolactone, 3-methyl-γ-butyrolactone, 4-methyl-γ-butyrolactone, β-propiolactone, and δ-valerolactone. Useful phosphates include but are not limited to trimethyl phosphate, triethyl phosphate, tris(2-chloroethyl)phosphate, tris(2,2,2-trifluoroethyl)phosphate, tripropyl phosphate, triisopropyl phosphate, tributyl phosphate, trihexyl phosphate, triphenyl phosphate, tritolyl phosphate, methyl ethylene phosphate and ethyl ethylene phosphate. Useful sulfones include but are not limited to non-fluorinated sulfones such as dimethyl sulfone, ethyl methyl sulfone, partially fluorinated sulfones such as methyl trifluoromethyl sulfone, ethyl trifluoromethyl sulfone, methyl pentafluoroethyl sulfone, ethyl pentafluoroethyl sulfone, and fully fluorinated sulfones such as di(trifluoromethyl)sulfone, di(pentafluoroethyl)sulfone, trifluoromethyl pentafluoroethyl sulfone, trifluoromethyl nonafluorobutyl sulfone, pentafluoroethyl nonafluorobutyl sulfone. Useful nitriles include but not limited to acetonitrile, propionitrile, and butyronitrile. Two or more of these solvents may be used in mixtures. Other solvents may be used as long as they are non-aqueous and aprotic, and are capable of dissolving the salts, such as N,N-dimethyl formamide, N,N-dimethyl acetamide, N,N-diethyl acetamide, and N,N-dimethyl trifluoroacetamide. In some exemplary embodiments of the present invention, the electrolyte compositions of the present invention comprise a mixture of solvents such as a mixture of ethylene carbonate and dimethyl carbonate.

When the electrolyte composition of the present invention comprises a mixture of solvents, each solvent may be present in an amount ranging from greater than 0 wt % to about 99 wt % based on a total weight of the solvents. For example, solvents A and B may each be present in an amount ranging from greater than 0 wt % to about 99 wt % wherein the sum of the wt % of A and the wt % of B equals 100 wt % of the solvents. Typically, when solvents A and B are present, each of solvents A and B is present in an amount ranging from about 10.0 wt % to about 90.0 wt % wherein the sum of the wt % of A and the wt % of B equals 100 wt % of the solvents. Further, when solvents A, B and C are present, each of solvents A, B and C is typically present in an amount ranging from about 10.0 wt % to about 80.0 wt % wherein the sum of the wt % of A, the wt % of B, and the wt % of C equals 100 wt % of the solvents.

Typically, the one or more solvents, in combination, are present in the electrolyte compositions of the present invention in an amount greater than 40.0 wt % based on a total weight of said electrolyte composition. In some exemplary embodiments, the one or more solvents, in combination, are present in the electrolyte compositions of the present invention in an amount ranging from about 50.0 to about 97.0 wt % based on a total weight of the electrolyte composition. In other exemplary embodiments, the one or more solvents, in combination, are present in the electrolyte compositions of the present invention in an amount ranging from about 88.0 to about 95.0 wt % based on a total weight of the electrolyte composition.

A number of commercially available solvents may be used in the present invention. Suitable commercially available solvents for used in the present invention include, but are not limited to, Purolyte® solvents commercially available from Novolyte Technologies (Independence Ohio).

4. Optional Additives

The electrolyte compositions of the present invention may further comprise one or more additives. Suitable optional additives include, but are not limited to, those described in U.S. Patent Publication No. US20090017386, such as a sultone (e.g., 1,3-propane sultone, and 1,4-butane sultone) and/or an acidic anhydride (e.g. succinic anhydride) to prevent or to reduce gas generation of the electrolytic solution as the battery is charged and discharged at temperatures higher than ambient temperature, and/or an aromatic compound (e.g., biphenyl and cyclohexylbenzene) to prevent overcharge of the battery.

B. Electrolyte Composition Forms

In another exemplary embodiment, the present invention relates to an electrolyte composition comprising functionalized metal oxide particles and at least one solvent, wherein the electrolyte composition is in the form of a dispersion.

The electrolyte compositions of the present invention may have one or more of the following forms.

1. Liquids

Typically, the electrolyte compositions of the present invention comprise a liquid matrix with one or more types of functionalized metal oxide particles and one or more types of ions each independently distributed throughout the liquid matrix (e.g., the one or more solvents). In some exemplary embodiments, the one or more types of functionalized metal oxide particles and one or more types of ions are each independently uniformly distributed throughout the liquid matrix (e.g., the one or more solvents).

In a further exemplary embodiment, the present invention relates to an electrolyte composition comprising functionalized metal oxide particles and at least one solvent, wherein the electrolyte composition is non-elastic when said functionalized metal oxide particles are present in an amount of at least about 10% by weight based on the weight of the electrolyte composition. One advantage of the present invention is the ability to add substantial amounts of functionalized metal oxide particles to the electrolyte without gelling the electrolyte (e.g., the electrolyte remains non-elastic). For example, the functionalized metal oxide particles may be present in the electrolyte in amounts of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, up to about 50 wt % based on the total weight of the electrolyte composition without causing the electrolyte to gel.

In another exemplary embodiment, the present invention relates to an electrolyte composition comprising functionalized metal oxide particles and at least one solvent, wherein the electrolyte composition is in the form of a dispersion. For example, the electrolyte, when combined with the functionalized metal oxide particles, may be dispersed such that no precipitates are formed for long periods of time (i.e., a stable dispersion), up to at least a few years or from about 3 to about 6 years. This provides a liquid electrolyte that is stable for extended periods of time.

In another exemplary embodiment, the invention relates to an electrolyte composition comprising functionalized metal oxide particles and at least one solvent, wherein the functionalized metal oxide particles are present in an amount of about 2% or less by weight based on the weight of the electrolyte composition. For example, the functionalized metal oxide particles may be present in an amount of about 2 wt % or less, to an amount that is greater than 0 wt %, bases upon the total weight of the electrolyte composition, or even about 1, 0.9, 0.8, 0.7, 0.6, 0.5, 0.4, 0.3, 0.2, 0.1, wt % or less based on the weight of the electrolyte composition. This provides an electrolyte with improved stability in operation at 60° C. over an electrolyte composition without silica. While not being bound by any particular theory, it is believed that the hydroxyl groups bound to the surface of the silica provide sources for the decomposition of electrolyte components, such as for example, decomposition of LiPF₆.

In another exemplary embodiment, the invention relates to an electrolyte composition comprising functionalized metal oxide particles, at least one solvent, and at least one scavenger. In one exemplary embodiment, the scavenger removes components that negatively affect the performance of the electrolyte, including water, hydroxides, acid, hydrogen halide, or combinations thereof from the electrolyte composition. In one exemplary embodiment, the scavenger may include at least one weakly basic compound capable of reducing reactivity of electrolyte components (e.g., PF₅), including but not limited to, silazanes, amides, amines, phosphites, phosphides, derivatives thereof, or combinations thereof.

In an even further exemplary embodiment, the invention relates to a battery having an electrolyte composition having functionalized metal oxide particles and at least one solvent, wherein the metal oxide particles in the electrolyte improve discharge capacity of the battery when cycling the battery at 60° C. as compared to electrolyte compositions without metal oxide particles. In another exemplary embodiment, the functionalized metal oxide particles increase the battery discharge capacity by at least about 10% after 4 cycles, or at least about 20% after 8 cycles, or at least about 25% after 12 cycles, or at least about 30% after 16 cycles, as compared to electrolyte compositions without metal oxide particles. In one exemplary embodiment, the functionalized metal oxide particles may be present in an amount of about 2 wt % or less, to an amount that is greater than 0 wt %, bases upon the total weight of the electrolyte composition, or even about I, 0.9, 0.8, 0.7, 0.6, 0.5, 0.4, 0.3, 0.2, 0.1, wt % or less based on the weight of the electrolyte composition.

In another exemplary embodiment, the invention relates to a battery having an electrolyte composition having functionalized metal oxide particles, at least one solvent, and at least one scavenger; wherein the at least one scavenger in the electrolyte increases conductivity stability of the battery as compared to the electrolyte composition without the scavenger. In an even further exemplary embodiment, the scavenger increases the conductivity of the battery by at least about 10% after 4 hours, or at least about 20% after 8 hours, or at least about 25% after 12 hours, or at least about 30% after 16 hours.

2. Gels

Depending on the amount and type of each component, the electrolyte compositions of the present invention may also comprise a gel matrix with one or more types of functionalized metal oxide particles and one or more types of ions each independently distributed throughout the gel matrix (e.g., the one or more solvents), desirably, uniformly distributed throughout the gel (e.g., the one or more solvents). In some exemplary embodiments, the electrolyte compositions of the present invention comprise a gel matrix, for example, when the total content of one or more types of functionalized metal oxide particles approaches about 40 to about 50 wt % (or greater) of the total weight of the electrolyte composition.

### II. Methods of Making Electrolyte Compositions

The present invention is further directed to methods of making electrolyte compositions. One benefit of the present invention is the simplicity of the methods of making electrolyte compositions. In one exemplary embodiment, the method of making an electrolyte composition comprises dispersing one or more types of functionalized metal oxide particles and one or more types of ions throughout the at least one solvent. The dispersing step may comprise adding one or more types of functionalized metal oxide particles and one or more salts (e.g., a lithium salt) to the at least one solvent, and blending the one or more types of functionalized metal oxide particles and one or more salts with the at least one solvent to form a stable dispersion of functionalized metal oxide particles and ions in the at least one solvent.

Typically, the methods of making electrolyte compositions of the present invention do not require any steps other than those described above. For example, the methods of making electrolyte compositions of the present invention do not require any polymerization step, any heating or cooling step, or any other composition treatment step (e.g., exposure to UV radiation, initiators, cross-linking agents, etc.).

In some embodiments, the methods of making an electrolyte composition results in an electrolyte composition that contains a minimal amount of water, typically, less than about 100, 90, 80, 70, 60, 50, 40, 30 (or less than about 20 or less than about 10 or less than about 5) ppm of water.

In a further exemplary embodiment, the present invention relates to a method of making an electrolyte composition comprising forming a dispersion having functionalized metal oxide particles in at least one first solvent, adding at least one second solvent to the dispersion, and removing the first solvent from the dispersion. For example the first solvent could be water or an alcohol or mixtures thereof and the second solvent could be a non-aqueous solvent used in the battery. The first solvent may be removed by distillation, or the like. Typically less than 1000 ppm remains in the dispersion, 500 ppm, 200 ppm, 100 ppm, 90 ppm, 80 ppm, 70 ppm, 60 ppm, 50 ppm, 40 ppm, 30 ppm, 20 ppm, or even less than 10 ppm remains in the dispersion.

### III. Applications/Uses

The present invention is further directed to methods of using electrolyte compositions. The methods of using electrolyte compositions of the present invention may comprise incorporating a given electrolyte composition into an article of manufacture. In one exemplary embodiment, the method of using an electrolyte composition of the present invention comprises forming an article of manufacture comprising (i) a housing, and (ii) any of the herein described electrolyte compositions positioned within the housing.

In some desired embodiments, the article of manufacture comprises an electrochemical cell or a battery comprising (i) a housing, and (ii) any of the herein described electrolyte compositions positioned within the housing. In some exemplary embodiments, the article of manufacture comprises a rechargeable battery. In other exemplary embodiments, the article of manufacture comprises a non-rechargeable (i.e., disposable) battery. In other exemplary embodiments, the article of manufacture comprises a capacitor.

When the article of manufacture comprises an electrochemical cell or a battery, the article of manufacture may further comprise a positive electrode, a negative electrode, and at least one separator positioned between the positive and negative electrodes. The positive electrode, the negative electrode, and the separator(s) may comprise any known materials suitable for use as positive electrodes, the negative electrodes, and the separators. For example, suitable positive electrodes include, but are not limited to, MnO₂, V₂O₅, CuO, TiS₂, V₆O₁₃, FeS₂, LiNO₂, LiCoO₂, LiMn₂O₄, LiNi_{0.33}C_{0.33}Mn_{0.33}O₄, organic sulfur compounds, and mixtures thereof. Suitable negative electrodes include, but are not limited to, graphite, Li, Li₄Ti₅O₁₂, polymers having an overall negative charge, tin-based glass oxides, and mixtures thereof. Suitable separators include, but are not limited to, microporous polymeric films such as a microporous poly(vinylidene fluoride) (PVDF) film with fumed silica or a microporous polyolefin separator.

In some exemplary embodiments, the electrochemical cell or battery comprises any of the herein described electrolyte compositions in combination with graphite and LiCoO₂ electrodes, In other exemplary embodiments, the electrochemical cell or battery comprises any of the herein described electrolyte compositions in combination with Li and LiCoO₂ electrodes.

In some exemplary embodiments, the electrochemical cell or battery comprises any of the herein described electrolyte compositions in combination with any of the herein described positive electrodes, negative electrodes, and separators, wherein at least one of (i) the positive electrode, (ii) the negative electrode, and (iii) the at least one separator.

In another exemplary embodiment, the present invention relates to a battery having an electrolyte composition comprising functionalized metal oxide particles and at least one solvent, wherein the metal oxide particles in the electrolyte lower irreversibility between charge/discharge cycles and capacity fade versus cycles.

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

### Formation of Exemplary Functionalized Metal oxide Particles

109.3 grams of LUDOX® TMA silica, 22 grams of deionized (DI) water and 56.5 grams of 2-propanol were added to a 500 ml, 3-neck jacketed flask. The flask was heated to 65° C. via a water bath and shaken on an orbital shaker at 165 RPM. At 65° C., 11.5 grams of hexamethyldisilazane was added dropwise. The cloudy mixture was shaken at 65° C. for a half hour, then the temperature of the water bath was increased to 70° C. and the mixture was shaken for 1 hour. Then, the temperature of the water bath was increased to 80° C. and the mixture was refluxed for 3 hours.

The mixture was cooled to room temperature and then filtered through a Buchner funnel using 131 paper from Advantec (Japan). The resulting powder was rinsed with water then dried in a vacuum oven at 120° C. for 1 hour. After crushing the dried material, the crushed material was further dried at 150° C. for 3 hours. The resulting yield was 39.7 grams of functionalized colloidal silica particles having a particle size of less than 100 nm.

### Example 2

### Formation of Exemplary Electrolyte Compositions

Electrolytes were prepared in a helium filled glove box by mixing the functionalized colloidal silica particles (FCSiP) formed in Example 1 into a 1M LiPF₆ ethylene carbonate-dimethyl carbonate mixture having a water content of less than 20 ppm in proportions as shown in Table 1 below.

TABLE 1
Exemplary Electrolyte Compositions

| | FCSiP | 1M LiPF₆ | FCSiP wt/vol. |
|---|---|---|---|
| Sample | (g) | (mL) | (%) |
| 1 | 0 | 3.0 | 0 |
| 2 | 0.25 | 3.0 | 8.3 |
| 3 | 0.50 | 3.0 | 16.6 |
| 4 | 0.75 | 3.0 | 25.0 |
| 5 | 1.00 | 3.0 | 33.0 |
| 6 | 1.00 | 2.0 | 50.0 |
| 7 | 1.00 | 1.0 | 100 (gel) |

### Example 3

### Formation of Exemplary Electrochemical Cells

Li-ion battery electrodes were prepared by mixing (i) PVDF-HFP (KYNAR FLEX® 2801, Arkema), (ii) SUPER P™ carbon black (Timcal), (iii) MCMB 25-28 graphite (Osaka Gas) or LiCoO₂ (SEIMI CO22) with (iv) acetone and (v) propylene carbonate in a laboratory blender using amounts as shown in Table 2 below.

TABLE 2
Anode and Cathode Compositions

| | SEIMI LiCoO₂ or | | | | | Casting Gap | Tape Density |
|---|---|---|---|---|---|---|---|
| Electrode | MCMB 25-28 | PVDF-HFP | SP | PC | Acetone | (mils) | (g/in²) |
| Cathode | 83.3 g | 7.1 g | 2.3 g | 18.1 g | 100 g | 14 | 0.142 |
| (SEIMI LiCoO₂) | | | | | | | |
| Anode graphite | 84.0 g | 6.6 g | 2.4 g | 16.8 g | 90 g | 10 | 0.109 |
| (MCMB 25-28) | | | | | | | |

The tape casting was performed with an automated doctor-blade system ensuring excellent tape homogeneity and electrode reproducibility. Plastic batteries were assembled from 1*1.5 in² electrodes laminated at 125° C. on A1 perforated foil current collectors coated with Acheson EB815 treatment (National Starch) for cathodes. Anodes were laminated on Cu grids treated by carbonization of a PVDF-HFP coating. Complete bicells were assembled by lamination at 100° C. of the electrodes on an Exxon-Teklon polypropylene microporous separator.

Laminated cells were dipped for 30 min in ether for extraction of the propylene carbonate plasticizer, then packaged in multilayer nylon/A1/SURLYN® foil. The assembly was then placed in a heated vacuum chamber at 120° C. overnight. The stack was then moved to a He filled glove box where each stack was filled with electrolyte and sealed. The assembled bicells had a theoretical capacity of 78.7 mAh (4.06 mAh/cm²), and a capacity matching ratio of 1.1 (i.e., 10% cathode capacity excess to account for passivation layer (SEI) formation).

Coin-cells were prepared and sealed in a glove-box using 1 cm² cathode discs, Li foil anodes and Whatman fiberglass separators.

Plastic and coin-cells were tested on a Maccor Series 4000 battery cycler. Impedance measurements were performed with 20 mV amplitude AC signal in the frequency range 100 kHz-0.1 Hz with a Solartron SI 1260 impedance analyzer connected to an SI 1287 potentiostat. Impedance spectra were fitted with equivalent circuits using ZView 2™ software (Scribner Associates).

Test Results For Li—LiCoO₂ Coin Cells

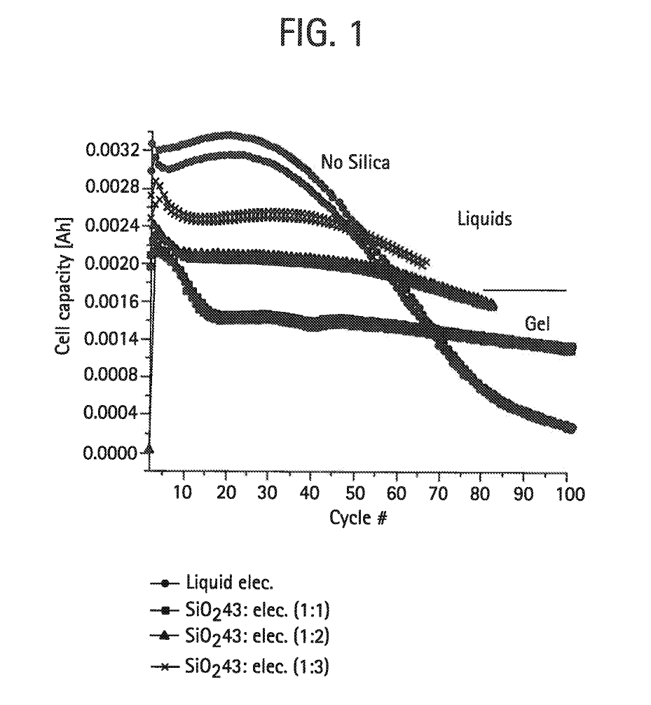

Four coin cells of identical capacity were prepared as discussed above using Samples 1, 5, 6 and 7 electrolytes from Example 2. All of the sample electrolytes were liquid, except for Sample 7, which formed a solid gel. Initial impedance measurements before charging indicated an increase in electrolyte resistance with silica contents. The resulting coin-cell capacity, all cycled at the same rate of C/2, decreased with silica contents. More importantly, the efficiency between charge and discharge capacities also increased, and less capacity fade was observed with addition of functionalized colloidal silica in the electrolyte as shown in FIG. 1.

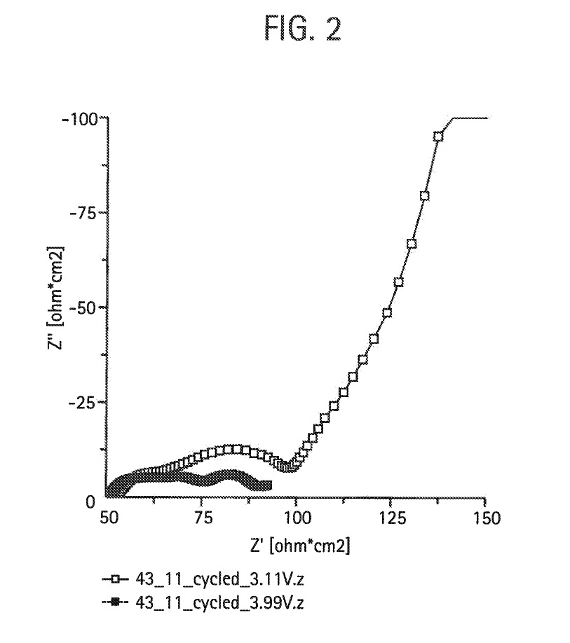

Irreversibility reduction was seen when the charge and discharge curves were superimposed. Initial capacity loss of the cells was caused by passivation layer formation, which was quick with functionalized colloidal silica, and then became stable. Without silica, it was a longer process, which caused the cells to fade gradually without ever becoming stable. Electrochemical impedance measurements of the cells, after cycling, revealed two semi-circles on the Nyquist plots as shown in FIG. 2. The impedance data could be fitted very well with the equivalent circuit depicted as an insert as shown in FIG. 2. From the fitting, values of Re (electrolyte and electrode/collector resistance), R1 (Li/electrolyte interface resistance) and R2 (cathode charge transfer resistance) were extracted. The attribution of R1 and R2 resistances was confirmed by comparing the impedance spectra of a coin-cell in the discharged state (3.1V) and the charged state (3.99V).

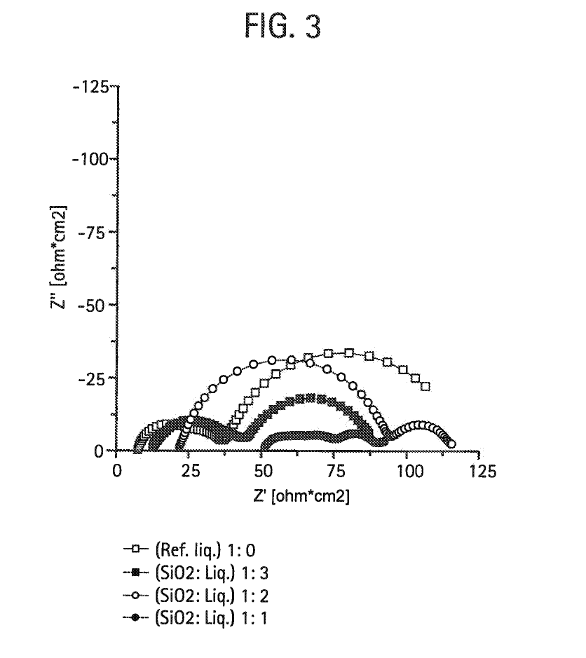

The low-frequency portion of the spectra was most affected by changing the state of charge as shown in FIG. 3. This was in agreement with the variation of LiCoO₂ conductivity, which transitions from blocking to non-blocking electrode with Li intercalation.

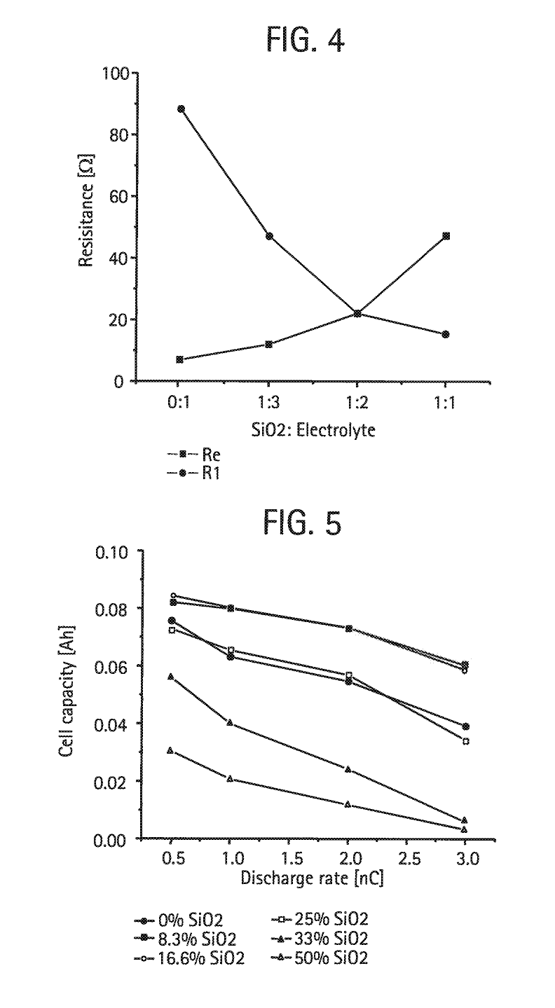

The impedance Nyquist plots of the coin-cells in the charged state, after cycling, were affected by functionalized colloidal silica content as shown in FIG. 4. Two clear trends can be observed from plotting the fitted resistance values Re and R1 versus functionalized colloidal silica content. Re value increased with functionalized colloidal silica content, indicating a lower ionic conductivity caused by viscosity increase due to addition of larger amounts of functionalized colloidal silica. R1 showed an opposite trend of decrease with functionalized colloidal silica content as shown in FIG. 4. Since R1 was attributed to the Li/electrolyte interface, the functionalized colloidal silica had a stabilizing effect on the Li/electrolyte interface resistance. It is known that Li deposition causes Li dendrites, which in turn increase the surface area of Li electrode, increasing its reactivity with electrolyte. Li dendrites may also become disconnected or poorly connected to Li foil, causing increase in the Li anode impedance. Increased viscosity of the electrolyte can limit the size of dendrites growth, resulting in lower impedance of the Li/electrolyte interface. The impurity getting effect of functionalized colloidal silica acting as a HF trap may also explain the lower impedance of the Li/electrolyte interface.

Test Results For Graphite-LiCoO₂ Plastic Cells

Six laminated plastic cells were prepared as described above using Sample electrolytes 1-6 from Example 2. The initial ESR was lower than pure electrolyte with 8.3 and 16.6 wt/vol. % functionalized colloidal silica content as shown in Table 3 below.

TABLE 3
Initial ESR, Re, R1 and R2 Values of Exemplary Plastic Cells

| | Cells initial ESR | Re | R1 | R2 |
|---|---|---|---|---|
| Sample | (Ω*cm²) | (Ω*cm²) | (Ω*cm²) | (Ω*cm²) |
| 1 | 6.12 | 8.45 | 9.98 | 6.86 |
| 2 | 5.04 | 6.22 | 5.35 | 12.97 |
| 3 | 5.09 | 5.45 | 7.41 | 6.68 |
| 4 | 6.73 | 8.52 | 7.41 | 10.57 |
| 5 | 9.05 | 14.86 | 9.10 | 19.85 |
| 6 | 9.34 | 15.2 | 4.93 | 17.08 |

The Ragone test for rate capability was performed at 0.5, 1, 2 and 3C discharge rates. Cells with the lowest initial ESR containing 8.3 and 16.6 wt/vol. % functionalized colloidal silica had better rate capability than the cell with pure electroyte as shown in FIG. 5.

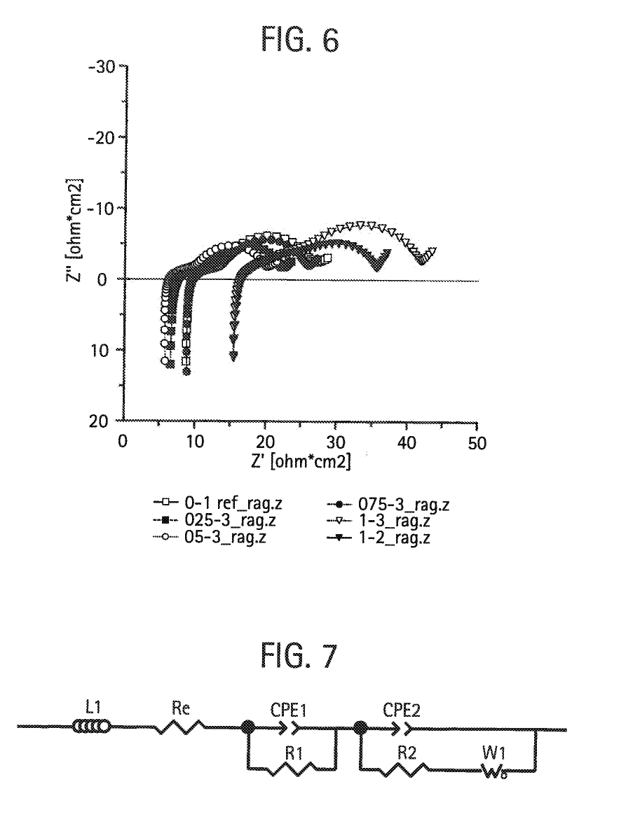

Impedance spectra after the Ragone test were taken in the charged state as shown in FIG. 6. The data was fitted with the equivalent circuit depicted in FIG. 7.

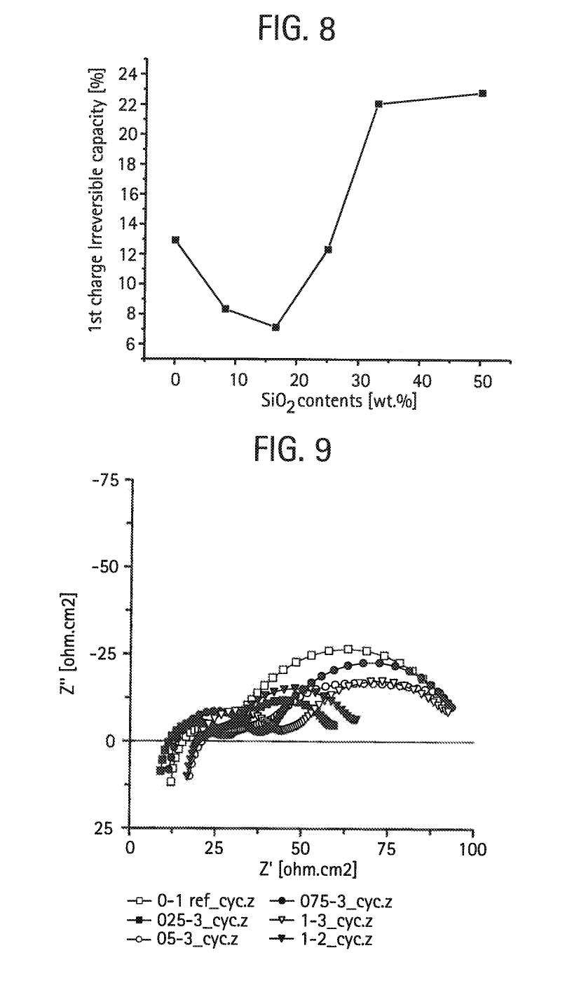

The irreversible capacity of the cells at first charge versus functionalized colloidal silica content in the sample electrolyte was plotted as shown in FIG. 8. The minimum was found to be for Sample 3 (i.e., a 16.6 wt/vol. % functionalized colloidal silica in the electrolyte), decreasing from 12.9% to 7.1%. Since H₂O and HF impurity reduction are causes of irreversibility during the first charging cycle of Li-ion batteries, the data suggested that moderate functionalized colloidal silica amounts were beneficial for trapping these impurities, causing the lower irreversible capacity observed during first cycle.

The EIS Nyquist plots of the cells, after cycling, confirmed that that cell containing Sample electrolyte 2 (i.e., a 8.3 wt/vol. % functionalized colloidal silica in the electrolyte) had the lowest impedance as shown in FIG. 9.

Overall Test Results

Both Li—LiCoO₂ coin-cells and graphite-LiCoO₂ plastic cells demonstrated the significant beneficial effect of adding nanosized functionalized colloidal silica in EC-DMC, LiPF₆ 1M liquid electrolyte. In the case of coin-cells with Li metal, irreversibility between charge and discharge cycles and capacity fade versus cycles were decreased. Impedance of the Li/electrolyte interface was also lowered. In the case of Li-ion cells, there was a reduction of initial ESR and first charge irreversible capacity with 16.6 wt/vol. % functionalized colloidal silica in the electrolyte. The discharge rate capability was improved, and there was less capacity fade at 25° C. and 60° C. C/2 rate cycling. This effect was believed to be attributable to a trapping effect of H₂O and HF impurities by the functionalized colloidal silica, as well as possible effect on the SEI chemistry, since functionalized colloidal silica nanoparticles may have access to the surface of the electrodes.

The addition of functionalized colloidal silica to at least some electrolytes reduced irreversible capacity at first charge and improved battery stability, especially at elevated temperature. The formation of Si—F bonds may explain its role as HF trapping agent. Unexpectedly, these beneficial effects were not accompanied by a loss of rate capability in the case of Li-ion cells for a functionalized colloidal silica amount of up to 16.6 wt/vol. % (i.e., Sample 3).

### Example 4

### High Temperature Cycling Results for Graphite/LiCoO2 Plastic Cells Containing 8% Functionalized Colloidal Silica in the Electrolyte

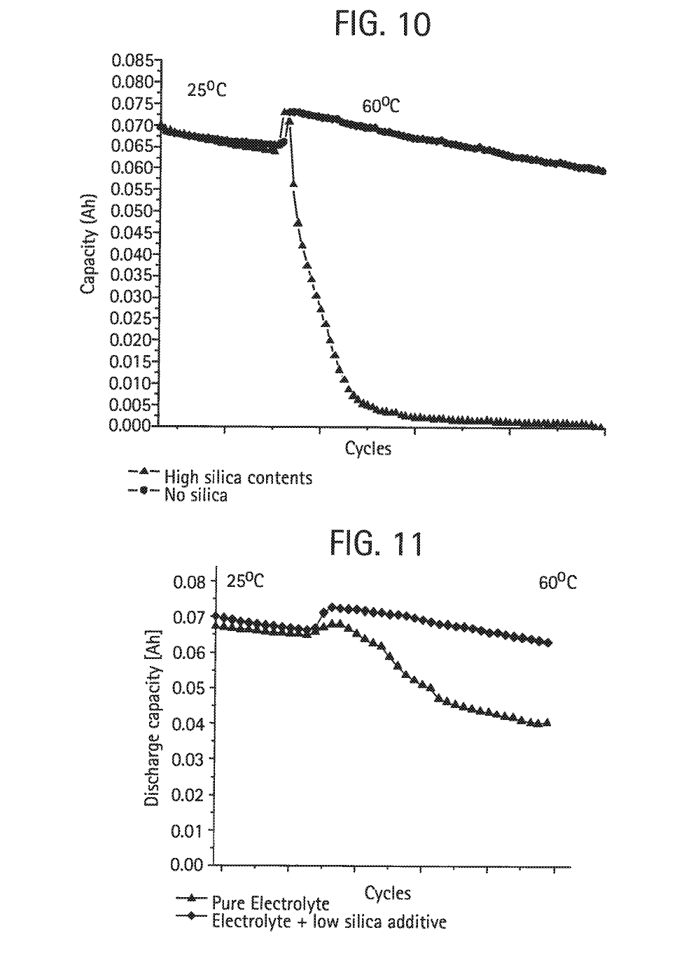

Two graphite/LiCoO₂ cells were assembled as in Example 3. One cell (Sample 7) included pristine electrolyte (1M LiPF₆ in EC/DMC) and the other (Sample 8) included the addition of 8 wt % colloidal silica dispersion to the electrolyte. FIG. 10 represents a comparison of the C/2 cycling of both cells. The performance at 25° C. is similar for both cells but once the temperature is raised to 60° C. the cell containing 8 wt % silica degrades rapidly. This is consistent with large amounts of silica degrading the LiPF₆ electrolyte at high temperature.

### Example 5

### High Temperature Cycling Results for Graphite/LiCoO₂ Plastic Cells Containing 0.2% Functionalized Colloidal Silica

Two graphite/LiCoO₂ cells were assembled as in Example 3. One cell (Sample 9) included pristine electrolyte (1M LiPF₆ in EC/DMC) and the other (Sample 10) included the addition of 0.2 wt % colloidal silica dispersion to the electrolyte. FIG. 11 depicts a comparison of the C/2 cycling of both cells. It can be seen clearly that at 25° C. the performance is similar. However, at 60° C. the silica containing cell shows less degradation.

### Example 6

### Effect of Scavenger

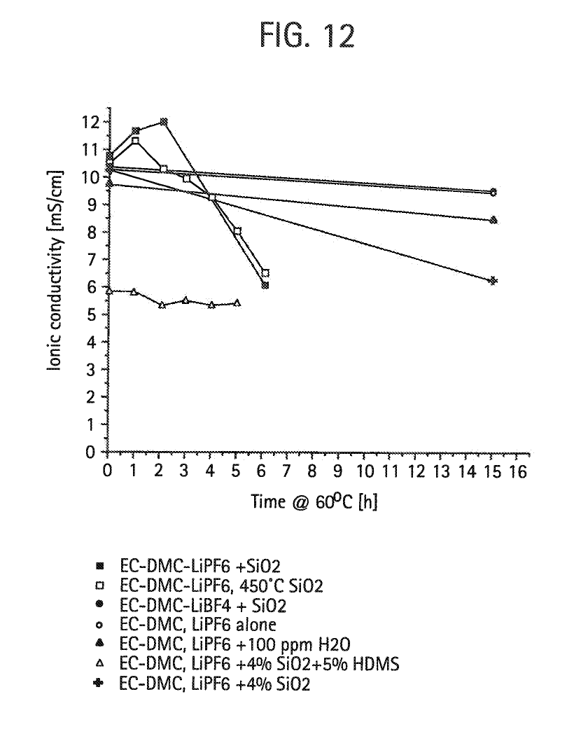

Three electrolyte compositions were prepared as in Example 2. In the first electrolyte composition (Sample 11), 1M LiPF₆ in EC/DMC alone was heated to 60° C. and the conductivity monitored versus time. In the second electrolyte composition (Sample 12), 1M LiPF₆ in EC/DMC was mixed with 4 wt % colloidal silica, and then heated to 60° C. and the conductivity monitored versus time. In the third electrolyte composition (Sample 13), 1M LiPF₆ in EC/DMC was mixed with 4 wt % colloidal silica that was treated with 5% HMDS (hexamethyldisilazane), and then heated to 60° C. and the conductivity monitored versus time. FIG. 12 shows the results. It can be seen that the conductivity decreases versus time showing the degradation of LiPF₆, especially with the addition of silica (Sample 12). However when 5% HMDS (hexamethyldisilazane) is added to the silica dispersion (Sample 13), the conductivity is stabilized, similar to the pristine electrolyte (Sample 11). This shows that a scavenger may be added in combination with silica to the battery electrolyte that would improve performance.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5%. . . . 50%, 51%, 52%. . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

1. An electrolyte composition comprising:
functionalized metal oxide particles;
at least one ion pair; and
at least one solvent;
wherein said functionalized metal oxide particles and said at least one ion pair are each independently distributed throughout said at least one solvent.

2. The electrolyte composition of claim 1, wherein said functionalized metal oxide particles comprise one or more functional groups covalently bonded to and extending from at least a portion of an outer surface of said functionalized metal oxide particles, said one or more functional groups comprising:
-M(R)ₓ(R′)_{y}
wherein
M comprises a metal or metalloid atom, each R independently comprises (i) a branched or unbranched, substituted or unsubstituted alkyl group, (ii) a branched or unbranched, substituted or unsubstituted alkenyl group, or (iii) a substituted or unsubstituted aryl group;
each R′ independently comprises (i) hydrogen, (ii) a branched or unbranched, substituted or unsubstituted alkyl group, (iii) a branched or unbranched, substituted or unsubstituted alkenyl group, or (iv) a substituted or unsubstituted aryl group;
x=0, 1, 2 or 3;
y=0, 1, 2 or 3; and
(x+y)=1, 2 or 3.

3. The electrolyte composition of claim 2, wherein:
each R independently comprises (i) a branched or unbranched C1-C8 alkyl group, (ii) a branched or unbranched C1-C8 alkyl group substituted with at least one fluoro, amino or glycidoxy substituent, (iii) a branched or unbranched C2-C8 alkenyl group, (iv) a branched or unbranched C2-C8 alkenyl group substituted with at least one fluoro, amino or glycidoxy substituent, (v) a phenyl group, or (vi) a phenyl group substituted with at least one fluoro substituent; and
each R′ independently comprises (i) hydrogen, (ii) a branched or unbranched C1-C8 alkyl group, (iii) a branched or unbranched C1-C8 alkyl group substituted with at least one fluoro, amino or glycidoxy substituent, (iv) a branched or unbranched C2-C8 alkenyl group, (v) a branched or unbranched C2-C8 alkenyl group substituted with at least one fluoro, amino or glycidoxy substituent, (vi) a phenyl group, or (vii) a phenyl group substituted with at least one fluoro substituent.

4. The electrolyte composition of claim 1, wherein said functionalized metal oxide particles are present in an amount ranging from greater than 0 to about 50 wt % based on a total weight of said electrolyte composition.

5. The electrolyte composition of claim 1, wherein said functionalized metal oxide particles are present in an amount ranging from about 3.0 to about 20.0 wt % based on a total weight of said electrolyte composition.

6. The electrolyte composition of claim 1, wherein said functionalized metal oxide particles have an average particle size of less than about 100 nanometers (nm).

7. The electrolyte composition of claim 1, wherein said electrolyte composition comprises a liquid.

8. The electrolyte composition of claim 1, wherein said at least one ion pair comprises a lithium ion.

9. The electrolyte composition of claim 8, wherein said lithium ion dissociates from one or more salts selected from lithium hexafluorophosphate, lithium imide, lithium perfluorosulphonimide (LiTFSI), lithium triflate, lithium tetrafluoroborate, lithium perchlorate, lithium iodide, lithium trifluorocarbonate, lithium nitrate, lithium thiocyanate, lithium hexafluoroarsenate, lithium methide, and combinations thereof.

10. The electrolyte composition of claim 1, wherein said at least one ion is present in an amount ranging from greater than 0 to about 1.0 wt % based on a total weight of said electrolyte composition.

11. The electrolyte composition of claim 1, wherein said functionalized metal oxide particles and said at least one ion are each independently uniformly distributed throughout said at least one solvent.

12. The electrolyte composition of claim 1, wherein said at least one solvent comprises ethylene carbonate, dimethyl carbonate, dimethyl carbonate, propylene carbonate, diethyl carbonate, polyethylene oxide, and mixtures thereof.

13. The electrolyte composition of claim 1, wherein said at least one solvent comprises a mixture of ethylene carbonate and dimethyl carbonate.

14. The electrolyte composition of claim 1, wherein said electrolyte composition contains less than 100 ppm of water.

15. The electrolyte composition of claim 1, wherein said metal oxide comprises silica, alumina, zirconia, titania and mixtures thereof.

16. An article of manufacture comprising:
a housing; and
the electrolyte composition of claim 1 positioned within the housing.

17. The article of manufacture of claim 16, wherein said article of manufacture comprises a battery.

18. The article of manufacture of claim 16, wherein said article of manufacture comprises a rechargeable battery.

19. The article of manufacture of claim 16, wherein said article of manufacture further comprises a positive electrode; a negative electrode; and at least one separator positioned between said positive and negative electrodes.

20. The article of manufacture of claim 16, wherein said article of manufacture comprises a capacitor.

21. A method of making the electrolyte composition of claim 1, said method comprising:
dispersing the functionalized metal oxide particles and the at least one ion throughout the at least one solvent,
wherein said method of making the electrolyte composition does not require any further step or steps after said dispersing step to form the electrolyte composition.

22-64. (canceled)
